(19) United States
(12) Patent Application Publication
(10) Pub. No.: US 2006/0171869 A1
(43) Pub. Date: Aug. 3, 2006

(54) Method of extracting lithium

(76) Inventors: Lawrence M. Anovitz, Knoxville, TN (US); James G. Blencoe, Harriman, TN (US); Donald A. Palmer, Oliver Springs, TN (US)

Correspondence Address: MACMILLAN, SOBANSKI & TODD, LLC, ONE MARITIME PLAZA, FIFTH FLOOR, 720 WATER STREET, TOLEDO, OH, 43604, US

(21) Appl. No.: 11/367,164

(22) Filed: Mar. 3, 2006

Related U.S. Application Data
(63) Continuation-in-part of application No. 11/119,536, filed on Apr. 29, 2005.
Application No. 11/119,536 is a continuation-in-part of application No. 10/706,583, filed on Nov. 12, 2003.

(51) Int. Cl. C01D 15/00; C22B 26/10; C22B 26/00; C22B 26/12

(52) U.S. Cl. 423/179.5; 75/745

(57) ABSTRACT

In a method of extracting lithium from a lithium bearing mineral, the mineral is reacted with a basic material of sufficient strength to dissolve the mineral, in order to produce a product mixture containing lithium. The lithium is then recovered from the product mixture. A method of extracting lithium from a lithium bearing mineral may consist of a two-step process. An industrial scale method of extracting lithium from a lithium bearing mineral can be conducted at a temperature not greater than about 500° C. and without the production of sulfur. A lithium metal can be produced by the method.

### CROSS-REFERENCE TO RELATED APPLICATIONS

This application is a continuation-in-part of co-pending U.S. utility application Ser. No. 11/119,536, filed Apr. 29, 2005, which is a continuation-in-part of co-pending U.S. utility application Ser. No. 10/706,583, filed Nov. 12, 2003, the disclosures of which are incorporated by reference herein.

### STATEMENT REGARDING FEDERALLY SPONSORED RESEARCH OR DEVELOPMENT

The United States Government has rights in this invention pursuant to Contract No. DE-AC05-00OR22725 between the United States Department of Energy and UT-Battelle, LLC.

### BACKGROUND OF THE INVENTION

This invention relates in general to methods of producing lithium, and in particular to methods of extracting lithium from lithium bearing minerals. Lithium is important for a number of uses, including production of batteries, glass and ceramics, manufacturing of aluminum, preparation of greases, rubbers, alloys and pharmaceuticals, treatment of concrete, and others. Worldwide, rechargeable lithium batteries power about 60% of cellular telephones and about 90% of laptop computers, and are important batteries for electric and hybrid vehicles.

Lithium is currently obtained either by extraction from lithium silicate minerals (primarily spodumene, but also petalite and lepidolite) or by solar evaporation of lake brines. According to the USDI Minerals Handbook (1995):
“Extracting lithium from spodumene entails an energy-intensive chemical recovery process. After mining, spodumene is crushed and undergoes a floatation beneficiation process to produce concentrate. Concentrate is heated to 1,075° C. to 1,100° C., changing the molecular structure of the mineral, making it more reactive to sulfuric acid. A mixture of finely ground converted spodumene and sulfuric acid is heated to 250° C., forming lithium sulfate. Water is added to the mixture to dissolve the lithium sulfate. Insoluble portions are then removed by filtration. The purified lithium sulfate solution is treated with soda ash, forming insoluble lithium carbonate that precipitates from solution. The carbonate is separated and dried for sale or use by the producer as feedstock in the production of other lithium compounds.”

The high costs of extracting lithium from silicate minerals has caused almost all production of lithium worldwide to shift to brine deposits. Thus, it would be desirable to provide an improved method of extracting lithium from minerals that has lower production costs, so that lithium mineral deposits that are either currently inactive or which have never been exploited may become economical.

### SUMMARY OF THE INVENTION

The present invention relates to a method of extracting lithium from a lithium bearing mineral. In the method, a lithium bearing mineral is reacted with a basic material of sufficient strength to dissolve the mineral, in order to produce a product mixture containing lithium. For example, the basic material may be a caustic material. The lithium is then recovered from the product mixture.

The invention also relates to a method of extracting lithium from a lithium bearing mineral consisting of a two-step process.

The invention also relates to an industrial scale method of extracting lithium from a lithium bearing mineral which is conducted at a temperature not greater than about 500° C.

The invention also relates to an industrial scale method of extracting lithium from a lithium bearing mineral which produces substantially no sulfur.

The invention also relates to a lithium metal produced in a process which includes a step of extracting lithium from a lithium bearing mineral with a caustic material.

The invention also relates to a lithium metal produced in a process which includes a step of extracting lithium from a lithium bearing mineral, wherein the process is conducted without preheating the lithium bearing mineral at a temperature greater than about 500° C.

The invention further relates to a lithium metal produced in a process which includes a step of extracting lithium from a lithium bearing mineral with substantially no sulfur production.

### DETAILED DESCRIPTION OF THE PREFERRED EMBODIMENTS

The present invention is a method of extracting lithium from a lithium bearing mineral. The method can be used to extract lithium from any type of mineral ore or mixtures of different mineral ores. Commonly, the mineral is a lithium silicate such as spodumene, petalite or lepidolite:

| LiAl(SiO₃)₂ | LiAl(Si₂O₅)₂ | K₂Li₃Al₄Si₇O₂₁(OH,F)₃ |
|---|---|---|
| spodumene | petalite | lepidolite |

The lithium bearing mineral is preferably granulated by crushing, grinding or the like to facilitate the extraction of the lithium. The average grain size of the crushed lithium bearing mineral usually affects the reactivity of the extraction process, with smaller grain sizes being more preferred in general.

The method involves reacting the lithium bearing mineral with a basic material of sufficient strength to dissolve the mineral, in order to produce a product mixture containing lithium. Any suitable type of basic material can be used in the method. For example, the basic material may be a caustic material which is an alkali metal hydroxide such as sodium hydroxide or potassium hydroxide. The basic material can be reacted with the lithium bearing mineral in any suitable manner. Typically, a solution of the basic material is reacted with the lithium bearing mineral. The basic solution can have any suitable concentration; typically it is fairly concentrated, e.g., comprising from about 30 wt % to about 80 wt % NaOH and from about 20 wt % to about 70 wt % water.

An example of a reaction pathway is shown below for extracting lithium from spodumene. Step (1) is the reaction of the spodumene with a caustic solution.

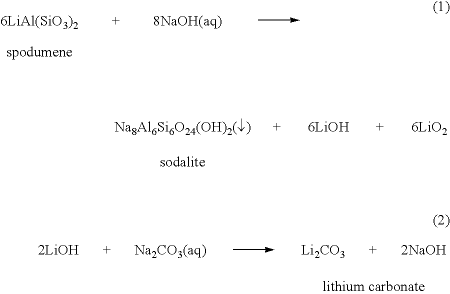

The reaction of the lithium bearing mineral with the basic material can be conducted using any suitable process conditions. Adjustments can be made in the temperature, time, fluid/solid ratio and/or pressure of the reaction, and the method of mixing the reactants, to ensure that at least most of the Li is extracted from the lithium bearing mineral. The reaction is usually conducted at a temperature not greater than about 500° C., sometimes not greater than about 300° C., and sometimes around 200° C.

The use of the basic material to extract lithium from the lithium bearing mineral is very effective so that it is not necessary to pre-heat the mineral to change its molecular structure before extraction, unlike the current lithium extraction process described above which preheats the lithium mineral to above 1,000° C. In the present method, the lithium bearing mineral is usually not pre-heated at all prior to reacting the lithium mineral with the basic material. If pre-heating is used, it is usually limited to a temperature not greater than the temperature during the reaction. The elimination or reduction of the pre-heating step allows the extraction method of the invention to be conducted at temperatures far below those used in current industrial practice, thereby providing a very large energy savings and lowering the cost of production. More generally, the invention provides an industrial scale method of extracting lithium from a lithium bearing mineral which is conducted at a temperature not greater than about 500° C. Of course, pre-heating can be used if it should be beneficial in a particular process.

The reaction of the lithium bearing mineral with the basic material produces a product mixture containing the extracted lithium. Depending on the particular reactants and the reaction conditions, the extracted lithium may be in different forms. As shown in reaction (1) above, when spodumene is reacted with a caustic solution, the product mixture contains lithium in solution.

The product mixture will also contain other products besides lithium that depend on the particular reactants and conditions. Preferably, any solid by-product in the product mixture is environmentally benign. As shown in reaction (1), the product mixture includes an environmentally benign sodalite group mineral as a solid by-product.

An experiment was performed in which 5.32 gms of spodumene powder were reacted with 203.99 gms of 50% NaOH for 3 days at 200° C. in a Teflon-lined, bolt-closure pressure vessel. After the experiment it was found that a large amount of the spodumene had reacted to sodalite and lithium in solution.

The next step of the method is to recover the lithium from the product mixture. This can be accomplished in any suitable manner, and it will depend on the particular reactants and conditions. As shown in reaction (1), the sodalite byproduct precipitates from the solution as a solid. Because the lithium is in solution, it is a relatively simple matter to separate the solution from the remaining solid. The lithium can be recovered from the solution in any suitable manner. In one embodiment of the method, the lithium is recovered from the solution by reaction with a carbonate to produce a lithium carbonate. Any suitable carbonate can be used, such as an alkali metal carbonate or bicarbonate, e.g., sodium carbonate (Na₂CO₃) or sodium bicarbonate (NaHCO₃). As shown in reaction (2) above, the addition of Na₂CO₃ to the lithium solution causes the precipitation of lithium carbonate (Li₂CO₃) from the solution. The carbonate for use in the method can be obtained from any suitable source, for example, by purchasing it or by obtaining it from another process. In one embodiment, the carbonate is obtained from a mineral carbonation process that can be used to sequester carbon dioxide, such as disclosed in copending U.S. utility application Ser. No. 10/706,583.

Alternatively, the lithium can be recovered from the solution by introducing carbon dioxide into the solution, for example, by bubbling gaseous carbon dioxide through the solution. This will produce lithium carbonate (as a precipitate), sodium bicarbonate and sodium hydroxide if used in step (2) of the above reaction pathway. The step of precipitating the lithium carbonate from solution might regenerate a substantial amount of the sodium hydroxide that is consumed in the extraction step (1).

When the lithium recovered from the product mixture is in the form of a compound, the compound can be used in its current form, or it can be subjected to additional reaction(s)/processing, for example, to produce lithium metal from the compound. The lithium carbonate from reaction (2) is the feedstock used for further lithium processing in most current industrial processes. Any suitable process can be used to produce lithium metal from the lithium carbonate, for example, by electrolysis of molten anhydrous lithium chloride after converting the lithium carbonate to lithium chloride.

Unlike the current lithium extraction process described above, the extraction method of the invention usually results in no net production of sulfur (sulfur or sulfur bearing material), with its potential for associated environmental hazards. More generally, the invention provides an industrial scale method of extracting lithium from a lithium bearing mineral which results in no net production of sulfur.

Further, the extraction method of the invention usually results in no net production of carbon dioxide (carbon dioxide or carbon dioxide bearing material). Moreover, the extraction method usually results in no net production of chlorine (chlorine or chlorine bearing material), unlike the brine method described above. Thus, the method of the invention is usually environmentally friendly.

Also, the method of the invention requires fewer steps than the current extraction process, which further reduces production costs. Specifically, the method does not require a step between steps (1) and (2) to add water to dissolve the lithium, because the lithium is already in solution after step (1) and it is directly reactable with the sodium bicarbonate to produce lithium carbonate. More generally, the invention may consist of a two-step process of extracting lithium from a lithium bearing mineral, where the lithium may be in the form of a compound such as lithium carbonate or any other non-mineral form.

In accordance with the provisions of the patent statutes, the principle and mode of operation of this invention have been described in its preferred embodiments. However, it must be understood that this invention may be practiced otherwise than as specifically described without departing from its spirit or scope.

What is claimed is:

1. A method of extracting lithium from a lithium bearing mineral comprising:
reacting a lithium bearing mineral with a basic material of sufficient strength to dissolve the mineral, to produce a product mixture containing lithium; and
recovering the lithium from the product mixture.

2. The method of claim 1 wherein the basic material comprises a caustic material.

3. The method of claim 1 wherein the method results in no net production of carbon dioxide.

4. The method of claim 1 wherein the method results in no net production of chlorine.

5. The method of claim 1 wherein the method results in no net production of sulfur.

6. The method of claim 1 wherein the reaction of the lithium bearing mineral with the basic material is conducted without preheating the lithium bearing mineral to a temperature greater than about 500° C.

7. The method of claim 1 wherein the method is conducted without an additional step of adding fluid between the steps of reacting the lithium bearing mineral with the basic material and recovering the lithium.

8. The method of claim 1 wherein the product mixture includes an environmentally benign solid by-product in addition to the lithium.

9. The method of claim 8 wherein the solid by-product is a sodalite group mineral.

10. The method of claim 1 wherein the lithium bearing mineral is a lithium silicate.

11. The method of claim 10 wherein the lithium silicate is selected from the group consisting of spodumene, petalite, lepidolite, and mixtures thereof.

12. The method of claim 1 wherein the lithium is recovered from the product mixture by reaction with a carbonate to produce a lithium carbonate.

13. The method of claim 12 wherein the carbonate is obtained from a mineral carbonation process that can be used to sequester carbon dioxide.

14. The method of claim 1 wherein the lithium is recovered from the product mixture by introducing carbon dioxide into the product mixture.

15. The method of claim 14 wherein the method regenerates at least a substantial portion of the basic material used to extract the lithium from the lithium bearing mineral.

16. The method of claim i wherein the lithium recovered from the product mixture is in the form of a compound, and wherein the method comprises an additional step of reacting the compound to produce lithium metal.

17. An industrial scale method of extracting lithium from a lithium bearing mineral which is conducted at a temperature not greater than about 500° C.

18. An industrial scale method of extracting lithium from a lithium bearing mineral with no net production of sulfur.

19. An industrial scale method of extracting lithium from a lithium bearing mineral with no net production of chlorine.

20. An industrial scale method of extracting lithium from a lithium bearing mineral with no net production of carbon dioxide.

21. A method of extracting lithium from a lithium bearing mineral consisting of a two-step process.

22. A lithium metal produced in a process which includes a step of extracting lithium from a lithium bearing mineral with a basic material of sufficient strength to dissolve the mineral.
